(19) United States
(12) Patent Application Publication
(10) Pub. No.: US 2005/0163218 A1
(43) Pub. Date: Jul. 28, 2005

(54) Method for estimating the dominant motion in a sequence of images

(75) Inventors: Francois Le Clerc, Rennes (FR); Sylvain Marrec, Rennes (FR)

Correspondence Address: THOMSON LICENSING INC., PATENT OPERATIONS, PO BOX 5312, PRINCETON, NJ, 08543-5312, US

(73) Assignee: Thomson Licensing S.A., Boulogne-Billancourt (FR)

(21) Appl. No.: 10/499,560

(22) PCT Filed: Dec. 12, 2002
(86) PCT No.: PCT/FR02/04316

(30) Foreign Application Priority Data
Dec. 19, 2001 (FR) 01/16466

(51) Int. Cl. H04N 7/12

(52) U.S. Cl. 375/240.16; 348/699

(57) ABSTRACT

The process performing a calculation of a motion vector field associated with an image, defining, for an image element with coordinates xi, yi, one or more motion vectors with components ui, vi, is characterized in that it also performs the following steps; modelling of the motion on the basis of a simplified parametric representation:
ui=tx+k.xi
vi=ty+k.yi with tx, ty components of a vector representing the translation component of the motion, k divergence factor characterizing the zoom component of the motion, robust linear regression in each of the two motion representation spaces defined by the planes and, x, y, u and v representing respectively the axes of the variables xi, yi, ui and vi, to give regression lines, calculation of the parameters tx, ty, and k on the basis of the slopes and ordinates at the origin of the regression lines. Applications relate to the selection of key images for video indexing or the generation of metadata.

The invention relates to a process and a device for estimating the dominant motion in a video shot. More precisely, the process is based on the analysis of the motion fields transmitted with the video in compression schemes using motion compensation. Such schemes are implemented in the MPEG-1, MPEG-2 and MPEG-4 video compression standards.

Motion analysis processes are known that rely on the estimation, on the basis of the motion vectors arising from the MPEG type compressed video streams, of a motion model which is usually affine:

$$\{ \begin{matrix}u ( {x}_{i} , {y}_{i} ) = a {x}_{i} + b {y}_{i} + c \\ v ( {x}_{i} , {y}_{i} ) = d {x}_{i} + e {y}_{i} + f\end{matrix}$$

where u and v are the components of a vector \vec{ω}ᵢ present at the position (xᵢ,yᵢ) of the motion field. The estimation of the affine parameters a, b, c, d, e and f of the motion model relies on a technique of least squares error minimization. Such a process is described in the article by M. A. Smith and T. Kanade “Video Skimming and Characterization through the Combination of Image and Language Understanding” (proceedings of IEEE 1998 International Workshop on Content-Based Access of Image and Video Databases, pages 61 and 70). The authors of this article use the parameters of the affine model of the motion, as well as the means \overline{u} and \overline{v} of the spatial components of the vectors of the field, to identify and classify the apparent motion. For example, to determine whether the motion is a zoom, they verify that there exists a point of convergence (x₀,y₀) of the vector field, such that u(x₀,y₀)=0 and v(x₀,y₀)=0, by means of the following condition:

$$\vert \begin{matrix}a & b \\ d & e\end{matrix} \vert \neq 0$$

The means of the components of the vectors \overline{u} and \overline{v} are analysed to test the hypothesis of a panning shot.

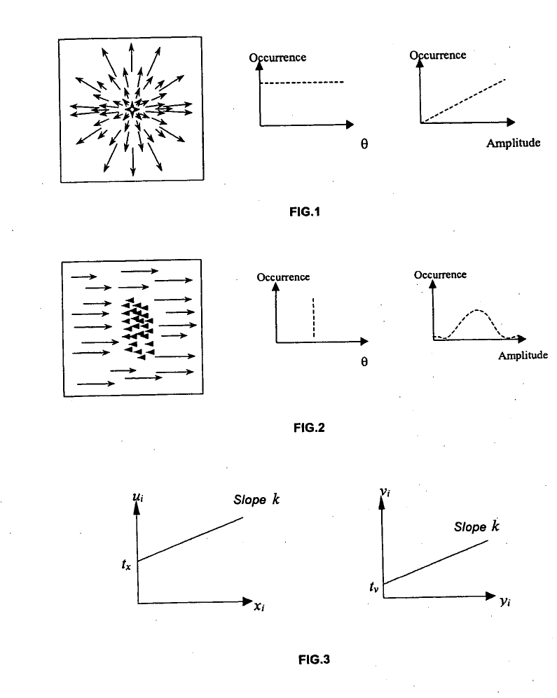

Motion analysis processes are also known that directly utilize the vector fields arising from the MPEG video stream, without involving the identification of a motion model. The article by O. N. Gerek and Y. Altunbasak “Key Frame Selection from MPEG Video Data” (proceedings of the Visual Communications and Image Processing '97 congress, pages 920 to 925) describes such a process. The method consists in constructing, for each motion field associated with an image of the MPEG binary train, two histograms of the vector field, one charting the occurrence of the vectors as a function of their direction, and the second as a function of their amplitudes. Examples of such histograms are represented in FIGS. 1 and 2: FIG. 1 illustrates a configuration where the apparent motion in the image is a zoom, while in FIG. 2 the dominant motion is a panning shot.

A thresholding of the variance associated with the number of motion vectors in each class (or “bin”) of the histogram, for each of the two histograms, is then used to identify the presence of dominant motions of “zoom” and “panning” type.

The methods such as that proposed by Gerek and Altunbasak provide purely qualitative information regarding the category of the dominant motion, while a quantitative estimate regarding the amplitude of the motion is often required. Methods such as that proposed by Smith and Kanade based on estimating a parametric model of motion provide this quantitative information, but are often fairly unreliable. Specifically, these methods take no account of the presence in the video scene processed of several objects following different apparent motions. Taking account of the vectors associated with secondary objects is liable to significantly falsify the least squares estimate of the parameters of the model of dominant motion. A secondary object is defined here as an object that occupies on the image a smaller area than that of at least one other object of the image, the object associated with the dominant motion being that which occupies the largest area in the image. Moreover, even in the presence of a single object in motion in the image, the vectors of the compressed video stream which serve as basis for the analysis of the motion do not always reflect the reality of the apparent real motion of the image. Specifically, these vectors have been calculated with the aim of minimizing the amount of information to be transmitted after motion compensation, and not of estimating the physical motion of the pixels of the image.

A reliable estimate of a model of motion on the basis of the vectors arising from the compressed stream requires the use of a robust method, automatically eliminating from the calculation the motion vectors relating to secondary objects not following the dominant motion, as well as the vectors not corresponding to the physical motion of the main object of the image.

Robust methods of estimating a parametric model of dominant motion have already been proposed in contexts different from the use of compressed video streams. An example of one is provided in the article by P. Bouthemy, M. Gelgon and F. Ganansia entitled “A unified approach to shot change detection and camera motion characterization”, published in the IEEE journal Circuits and Systems for Video Technology volume 9 No. 7, October 1999, pages 1030 to 1044. These methods have the drawback of being very complex to implement.

The invention presented here is aimed at alleviating the drawbacks of the various families of methods for estimating dominant motion that are presented above.

A subject of the invention is a process for detecting a dominant motion in a sequence of images performing a calculation of a motion vector field associated with an image, defining, for an image element with coordinates xi, yi, one or more motion vectors with components ui, vi, characterized in that it also performs the following steps:
modelling of the motion on the basis of a simplified parametric representation:
   ui=tx+k.xi
   vi=ty+k.yi
with
tx, ty components of a vector representing the translation component of the motion,
k divergence factor characterizing the zoom component of the motion,
   robust linear regression in each of the two motion representation spaces defined by the planes (x,u) and (y,v), x, y, u and v representing respectively the axes of the variables xi, yi, ui and vi, to give regression lines,
   calculation of the parameters tx, ty, and k on the basis of the slopes and ordinates at the origin of the regression lines.

According to a mode of implementation, the robust regression is the method of the least median of the squares which consists in searching, among a set of lines j, ri,j being the residual of the ith sample with coordinates xi, ui or yi, vi, with respect to a line j, for the one providing the median value of the set of squares of the residuals which is a minimum:

$${min}_{j} \text{(} {med}_{i} {r}_{i , j}^{2} \text{)}$$

According to a mode of implementation, the search for the least median of the squares of the residuals is applied to a predefined number of lines each determined by a pair of samples drawn randomly in the space of representation of the motion considered.

According to a mode of implementation, the process performs, after the robust linear regression, a second nonrobust linear regression making it possible to refine the estimates of the parameters of the motion model. This second linear regression may exclude the points in the representation spaces whose regression residual arising from the first robust regression exceeds a predetermined threshold.

According to a mode of implementation, the process performs a test of equality of the direction coefficients of the regression lines calculated in each of the representation spaces, this test being based on a comparison of the sums of the squares of the residuals obtained firstly by performing two separate regressions in each representation space, secondly by performing a global slope regression on the set of samples of the two representation spaces, and, in the case where the test is positive, estimates the parameter k of the model by the arithmetic mean of the direction coefficients of the regression lines obtained in each representation space.

The invention also relates to a device for the implementation of the process.

By utilizing a very simplified but nevertheless sufficiently realistic parametric model of the dominant motion in a video image, the process allows the implementation of robust methods of identification of the motion model at reduced cost. More precisely, the main benefit of the process described in the invention resides in the use of a judicious space of representation of the components of the motion vectors, which makes it possible to reduce the identification of the parameters of the motion model to a double linear regression.

Other features and advantages of the invention will become clearly apparent in the following description given by way of nonlimiting example and offered with regard to the appended figures which represent:

FIG. 1, a field of theoretical motion vectors corresponding to a “zoom”,

FIG. 2, a field of theoretical motion vectors corresponding to a scene for which the dominant motion of the background is of “panning” type, and which also comprises a secondary object following a motion distinct from the dominant motion,

FIG. 3, an illustration of the spaces of representation of the motion vectors used in the invention,

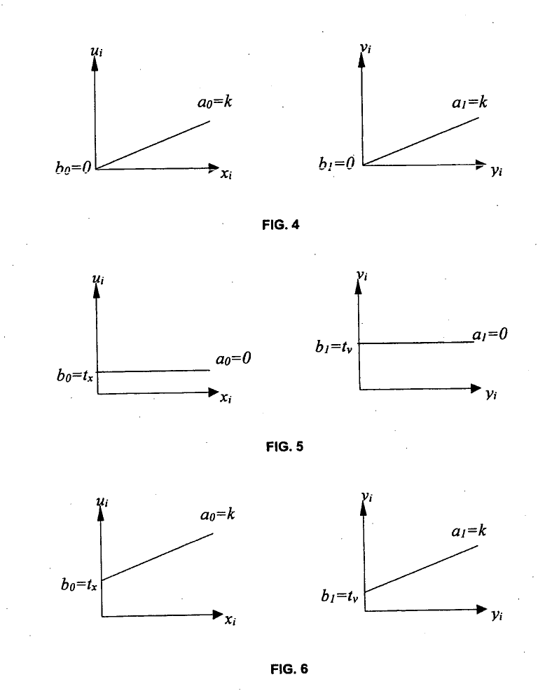

FIG. 4, the distribution of the theoretical vectors for a zoom motion centred in the representation spaces used in the invention,

FIG. 5, the distribution of the theoretical vectors for a global oblique translation motion of the image in the representation spaces used in the invention,

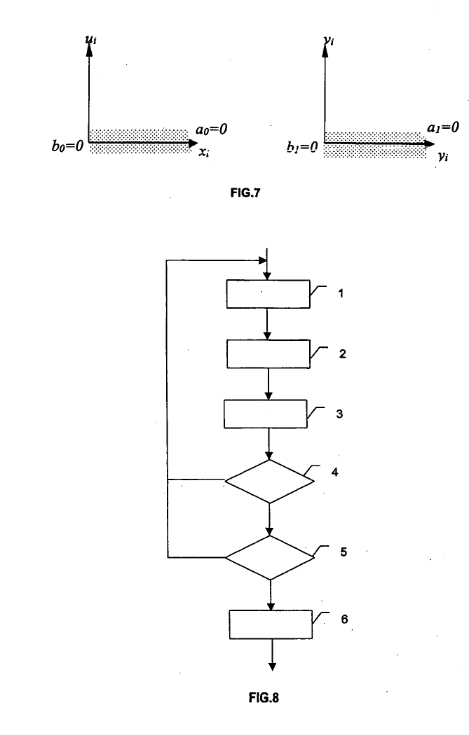

FIG. 6, the distribution of the theoretical vectors for a combined motion of translation and zoom in the representation spaces used in the invention,

FIG. 7, the distribution of the theoretical vectors for a static scene (zero motion) in the representation spaces used in the invention,

FIG. 8, a flowchart of the method of detecting dominant motion.

The characterization of dominant motion in a sequence of images involves the identification of a parametric model of apparent dominant motion. In the context of the utilization of motion vector fields arising from compressed video streams, this model must represent the apparent motion in the 2D image plane. Such a model is obtained by approximating the projection onto the image plane of the motion of the objects in three-dimensional space. By way of example, the affine model with six parameters (a, b, c, d, e, f) presented above is commonly adopted in the literature.

The process proposed consists, basically, in identifying this parametric model of motion, on the basis of fields of motion vectors that are provided in the video stream so as to perform the decoding thereof, when the coding principle calls upon motion compensation techniques such as utilized for example in the MPEG-1, MPEG-2 and MPEG-4 standards. However, the process described in the invention is also applicable to motion vector fields that have been calculated by a separate procedure on the basis of the images constituting the processed video sequence.

Within the context of the present invention, the motion model adopted is derived from a simplified linear model with four parameters (tₓ,t_{y}, k, θ) that we shall call SLM (the acronym standing for Simplified Linear Model), defined by:

$$[ \begin{matrix}{u}_{i} \\ {v}_{i}\end{matrix} ] = [ \begin{matrix}{t}_{x} \\ {t}_{y}\end{matrix} ] + [ \begin{matrix}k - θ \\ θ k\end{matrix} ] [ \begin{matrix}{x}_{i} - {x}_{g} \\ {y}_{i} - {y}_{g}\end{matrix} ]$$

with:
(uᵢ,vᵢ)^{t}: components of the apparent motion vector associated with the pixel of the image plane with coordinates (xᵢ,yᵢ)^{t},
(x_{g},y_{g})^{t}: coordinates of the reference point for the approximation of the 3D scene filmed by the camera as a 2D scene; this reference point will be regarded as the point with coordinates (0,0)^{t} of the image,
(tₓ,t_{y})^{t}: vector representing the translation component of the motion,
k: divergence term representing the zoom component of the motion,
θ: angle of rotation of the motion about the axis of the camera.

The objective sought is to identify the dominant motions caused by the movements and the optical transformations of the cameras, for example an optical zoom, in the video sequences. It involves in particular identifying the camera motions that are statistically the most widespread in the composition of the video documents, grouping together chiefly the motions of translation and of zoom, their combination, and absences of motion, that is to say the static or still shots. The camera rotation effects, very rarely observed in practice, are not taken into account: the model is therefore restricted to the three parameters (tₓ,t_{y}, k) by making the assumption that θ≈0.

We then have two linearity relations between the components of the vectors and their spatial position in the image:

$$\{ \begin{matrix}{u}_{i} = {t}_{x} + k \cdot {x}_{i} \\ {v}_{i} = {t}_{y} + k \cdot {y}_{i}\end{matrix}$$

The advantage of this simplified parametric representation of the motion is that the parameters tₓ, t_{y} and k, respectively describing the two components of translation and the zoom parameter of the motion model, may be estimated by linear regression in the spaces of representation of the motion uᵢ=f(xᵢ) and vᵢ=f(yᵢ). Thus, as illustrated by FIG. 3, the representation of a motion vector field in these spaces generally provides, for each of them, a cluster of points distributed around a line of slope k.

The procedure for estimating the parameters of the simplified motion model is based on the application of a linear regression of robust type in each of the motion representation spaces. Linear regression is a mathematical operation that determines the best fit line to a cluster of points, for example by minimizing the sum of the squares of the distances from each point to this line. This operation is, within the context of the invention, implemented with the aid of a robust statistical estimation technique, so as to guarantee a degree of insensitivity with regard to the presence of outliers in the data. Specifically, the estimation of the model of dominant motion must disregard:
the presence in the image of several objects some of which follow secondary motions distinct from the dominant motion,
the presence of motion vectors not representing the physical motion of the objects. Specifically, the motion vectors transmitted in a compressed video stream have been calculated with the aim of minimizing the amount of residual information to be transmitted after motion compensation and not with the aim of providing the real motion of the objects constituting the imaged scene.

FIG. 8 sketches the various steps of the method of estimating the dominant motion in the sequence. Each of these steps is described more precisely in what follows.

A first step 1 performs a normalization of the motion vector fields each associated with an image of the video sequence processed. These vector fields are assumed to have been calculated prior to the application of the algorithm, with the aid of a motion estimator. The estimation of the motion can be performed for rectangular blocks of pixels of the image, as in the so-called “block-matching” methods, or provide a dense vector field, where a vector is estimated for each pixel of the image. The present invention deals preferentially, but not exclusively, with the case where the vector fields used have been calculated by a video encoder and transmitted in the compressed video stream for decoding purposes. In the typical case where the encoding scheme used complies with one of the MPEG-1 or MPEG-2 standards, the motion vectors are estimated for the current image at the rate of one vector per rectangular block of the image, relative to a reference frame whose temporal distance from the current image is variable. Moreover, for certain so-called “B” frames predicted bidirectionally, two motion vectors may have been calculated for one and the same block, one pointing from the current image to a past reference frame and the other from the current image to a future reference frame. A step of normalizing the vector fields is therefore indispensable so as to deal, in the subsequent steps, with vectors calculated over temporal intervals of equal durations and pointing in the same direction. Paragraph 3.2 of the article by V. Kobla and D. Doermann entitled “Compressed domain video indexing techniques using DCT and motion vector information in MPEG video”, Proceedings of the SPIE vol. 3022, 1997, pages 200 to 211, provides an exemplary method making it possible to perform this normalization. Other more simple techniques based on linear approximations of the motion over the MPEG vectors calculation intervals may also be used.

The second step referenced 2 performs a construction of the motion representation spaces presented above. Each vector \vec{ω}ᵢ of the motion field, with components (uᵢ,vᵢ)^{t} and with position (xᵢ,yᵢ)^{t}, is represented by a point in each of the two spaces uᵢ=f(xᵢ) and vᵢ=f(yᵢ).

Each pair of points (xᵢ,uᵢ) and (yᵢ,vᵢ) corresponding to the representation of a vector of the motion field may be modelled relative to the regression lines in each of the spaces by:

$$\{ \begin{matrix}{u}_{i} = {a}_{0} \cdot {x}_{i} + {b}_{0} + {ɛ}_{ui} \\ {v}_{i} = {a}_{1} \cdot {y}_{i} + {b}_{1} + {ɛ}_{vi}\end{matrix}$$

where
(a₀,b₀) are the parameters of the regression line to be calculated in the space uᵢ=f(xᵢ); εᵤᵢ is the corresponding residual error.
(a₁,b₁) are the parameters of the regression line to be calculated in the space vᵢ=f(yᵢ); εᵥᵢ is the corresponding residual error.

FIG. 3 illustrates clusters of points obtained after construction of these two spaces on the basis of a normalized motion vector field.

The parameters (a₀,b₀) and (a₁,b₁) obtained on completion of the linear regressions in each of the representation spaces provide estimates of the parameters of the dominant motion model. Thus, the slopes a₀ and a₁ correspond to a double estimate of the divergence parameter k characterizing the zoom component, while the ordinates at the origin b₀ and b₁ correspond to an evaluation of the translation components tₓ and t_{y}.

FIGS. 4 to 7 show a few examples of possible configurations.
distribution of the data in the case of a centred zoom for FIG. 4,
distribution of the data in the case of oblique translation motion for FIG. 5,
distribution of the data in the case of an off-centred zoom (motion combining a zoom and a translation) for FIG. 6,
distribution of the data in the case of an absence of motion for FIG. 7.

The next step 3 performs a robust linear regression for each of the motion representation spaces, with the aim of separating the data points representative of the real dominant motion from those corresponding, either to the motion of secondary objects in the image, or to vectors that do not convey the physical motion of the pixels with which they are associated.

There exist several families of robust estimation techniques. According to a preferential embodiment of the invention, the regression lines are calculated in such a way as to satisfy the criterion of the least median of the squares. The method of calculation, presented briefly below, is described more completely in paragraph 3 of the article by P. Meer, D. Mintz and A. Rosenfeld “Robust Regression Methods for Computer Vision: A Review”, published in International Journal of Computer Vision, volume 6 No. 1, 1991, pages 59 to 70.

Calling r_{i,j} the residual of the i^{th} sample of a motion representation space in which one seeks to estimate the set Eⱼ of regression parameters (slope and intercept of the regression line), Eⱼ is calculated so as to satisfy the following criterion:

$${min}_{{E}_{j}} \text{(} {med}_{i} {r}_{i , j}^{2}$$

The residual r_{i,j} corresponds to the residual error εᵤᵢ or εᵥᵢ—according to the representation space considered—associated with the modelling of the i^{th} sample by the regression line with parameters Eⱼ. The solution to this nonlinear minimization problem requires a search for the line defined by Eⱼ among all possible lines. In order to restrict the calculations, the search is limited to a finite set of p regression lines, defined by p pairs of points drawn randomly from the samples of the representation space under study. For each of the p lines, the squares of the residuals are calculated and sorted in such a way as to identify the square of the residual squared which exhibits the median value. The regression line is estimated as that which provides the smallest of these median values of the squares of the residuals.

Selecting the regression line solely on the square of the median residual, rather than on the set of residuals, gives the regression procedure iti robust nature. Specifically, it makes it possible to ignore residuals of extreme values, liable to correspond to outlying data points and hence to falsify the regression.

By testing for example p=12 lines, the probability that at least one of the p pairs consists of two nonoutlying samples, that is to say that are representative of the dominant motion, is very close to 1. If a proportion of outlying samples is less than 50%, as assumed, such a pair comprising no outlying sample provides a regression line that is a better fit to the cluster of samples—hence exhibiting a lower median square residual—than any pair of points comprising at least one outlying sample. It is then almost certain that the regression line ultimately obtained is defined by two nonoutlying samples, thereby guaranteeing the robustness of the method with regard to outlying samples.

The regression lines obtained by robust estimation in each representation space are thereafter used to identify the outlying samples. With this aim, a robust estimate \hat{σ} of the standard deviation of the residuals associated with the nonoutlying samples is calculated, as a function of the median value of the square of the residual corresponding to the best regression line found, under the assumption that they follow a Gaussian distribution, and any sample the absolute value of whose residual exceeds K times \hat{σ} is labelled as an outlying sample. The value of K can advantageously be fixed at 2.5.

However, in this step 3, conventional, nonrobust, linear regressions are finally performed on the samples of each representation space, excluding the samples identified as outliers. These regressions provide refined estimates of the parameters (a₀,b₀) and (a₁,b₁) which will be used subsequently in the process.

The next step 4 performs a test of linearity of the regression lines in each of the representation spaces. This test is aimed at verifying that the clusters of points in each space are actually approximately distributed along lines, this in no way guaranteeing the routine existence of a regression line.

The linearity test is performed, in each representation space, by comparing the standard deviation of the residual arising from the linear regression pertaining to the nonoutlying samples with a predetermined threshold. The value of the threshold depends on the temporal normalization applied to the motion vectors in step 1 of the process. In the case where, after normalization, each vector represents a displacement corresponding to the time interval separating two interlaced frames, i.e. 40 ms for a transmission at 50 Hz, this threshold may advantageously be fixed at 6.

If at least one of the linearity tests performed in the two representation spaces fails, then the motion field corresponding to the current image is considered not to allow reliable estimation of a model of dominant motion. A flag signalling the failure of the dominant motion estimation procedure is then set and the next image is processed.

In the converse case, we go to the next step 5, which consists in verifying that the slopes a₀ and a₁, which provide a double estimate of the divergence parameter k of the motion model, do not differ significantly. The test of equality of two regression slopes is a known problem, which is dealt with in certain statistical works; it will for example be possible to consult the chapter devoted to the analysis of variance in the book by C. R Rao “Linear Statistical Inference and its Applications” published by Wiley (2^{nd} edition). This test is performed in a conventional manner by calculating a global regression slope pertaining to the set of nonoutlying samples of the two representation spaces for the motion vector field. We then form the ratio of the sum of the squares of the residuals relating to this global slope estimate over the set of data, to the sum over the two spaces of the sums of the squares of the residuals relating to the separate regressions—pertaining only to the nonoutlying samples. This ratio is compared with a predetermined threshold; if the ratio is above the threshold, the assumption of equality of the regression slopes in the two motion representation spaces is not statistically valid. A flag signalling the failure of the dominant motion estimation procedure is then set and the next image is processed. In the case where the result of the test is positive, the value of the divergence coefficient k of the dominant motion model is estimated by the arithmetic mean of the regression slopes a₀ and a₁ obtained in each of the representation spaces. The parameters tₓ and t_{y} are estimated respectively by the values of the intercepts b₀ and b₁ arising from the linear regressions in the representation spaces.

In the case where the motion model is regarded as valid, that is to say if the tests performed in steps 4 and 5 were passed with success, a classification of the dominant motion is performed during the next step referenced 6.

The vector θ=(k, tₓ,t_{y})^{t} of estimated parameters is utilized to decide the category in which to class the dominant motion, namely:
static,
pure translation,
pure zoom,
translation combined with a zoom.

The classification algorithm is based on tests of nullity of the parameters of the model, in accordance with the table below:

| Model | Parameters | | |
|---|---|---|---|
| Static | k = 0 | tₓ = 0 | t_{y} = 0 |

| | | |
|---|---|---|
| Translation | k = 0 | (tₓ, t_{y}) ≠ (0, 0) |

| | | | |
|---|---|---|---|
| Zoom | k ≠ 0 | tₓ = 0 | t_{y} = 0 |

| | | |
|---|---|---|
| Zoom + translation | k ≠ 0 | (tₓ, t_{y}) ≠ (0, 0) |

According to a simple technique, the tests of nullity of the estimates of the parameters of the model may be performed by simply comparing their absolute value with a threshold. More elaborate techniques, based on statistical modelling of the data distribution, may also be employed. Within this statistical framework, an exemplary algorithm for deciding the nullity of the parameters of the model based on likelihood tests is presented in the article by P. Bouthemy, M. Gelgon and F. Ganansia entitled “A unified approach to shot change detection and camera motion characterization”, published in the IEEE journal Circuits and Systems for Video Technology volume 9 No. 7, October 1999, pages 1030 to 1044.

An application of the invention relates to video indexing on the basis of the selecting of key images.

Specifically, the video indexing procedure generally begins with a preprocessing, which attempts to restrict the volume of information to be processed in the video stream to a set of key images selected from the sequence. The video indexing processing, and in particular the extracting of the visual attributes, is performed exclusively on these key images, each of which is representative of the content of a segment of the video. Ideally, the set of key images should form an exhaustive summary of the video, and the redundancies between the visual content of the key images should be avoided, so as to minimize the computational burden of the indexing procedure. The process for estimating dominant motion inside each video shot makes it possible to optimize the selecting of the key images, inside each shot, in relation to these criteria, by adapting it to the dominant motion. It is for example possible to aggregate the horizontal (respectively vertical) translations of the image, estimated by the parameter tₓ (respectively t_{y}) inside a shot, and to sample a new key image once the aggregate exceeds the width (respectively the height) of an image.

The process described can also be utilized for the generation of metadata. Dominant motions often coincide with the camera motions during the shooting of the video. Certain directors use particular camera motion sequences to communicate certain emotions or sensations to the viewer. The process described in the invention can make it possible to detect these particular sequences in the video, and consequently to provide metadata relating to the atmosphere created by the director in certain portions of the video. Another application of dominant motion detection is the detection or aid with the detection of breaks in shots. Specifically, an abrupt change of the properties of the dominant motion in a sequence can only be caused by a break in shot.

Finally, the process described in the invention allows the identification, in each image, of the support of the dominant motion. This support in fact coincides with the set of pixels whose associated vector has not been identified as an outlier, within the sense of the dominant motion. Knowledge of the support of the dominant motion provides a segmentation of the object which follows this motion. This segmentation can be utilized either to perform a separate indexing of the constituent objects of the image, thus allowing the processing of partial requests pertaining to the objects and not to the totality of images, or within the framework of object based video compression algorithms, such as for example those specified in the MPEG-4 video compression standard.

1. Process for estimating a dominant motion in a sequence of images performing a calculation of a motion vector field associated with an image, defining, for an image element with coordinates xi, yi, one or more motion vectors with components ui, vi, wherein it also performs the following steps:
modelling of the motion on the basis of a simplified parametric representation:
ui=tx+k.xi
vi=ty+k.yi
with
tx, ty components of a vector representing the translation component of the motion,
k divergence factor characterizing the zoom component of the motion,
robust linear regression in each of the two motion representation spaces defined by the planes and, x, y, u and v representing respectively the axes of the variables xi, yi, ui and vi, to give regression lines,
calculation of the parameters tx, ty, and k on the basis of the ordinates at the origin and slopes of the regression lines.

2. Process according to claim 1, wherein the robust regression is the method of the least median of the squares which consists in searching, among a set of lines j,, r_{i,g} being the residual of the ith sample with coordinates xi, ui or yi, vi, with respect to a line j, for the one providing the median value of the set of squares of the residuals which is a minimum.

3. Process according to claim 2, wherein the search for the least median of the squares of the residuals is applied to a predefined number of lines each determined by a pair of samples drawn randomly in the space of representation of the motion considered.

3. Process according to claim 1, wherein it performs, after the robust linear regression, a second nonrobust linear regression making it possible to refine the estimates of the parameters of the motion model.

4. Process according to claim 3, wherein the second linear regression excludes the points in the representation spaces whose regression residual arising from the first robust regression exceeds a predetermined threshold.

5. Process according to claim 1, wherein it performs a test of equality of the direction coefficients of the regression lines calculated in each of the representation spaces, this test being based on a comparison of the sums of the squares of the residuals obtained firstly by performing two separate regressions in each representation space, secondly by performing a global slope regression on the set of samples of the two representation spaces, and, in the case where the test is positive, that it estimates the parameter k of the model by the arithmetic mean of the direction coefficients of the regression lines obtained in each representation space.

6. Process according to claim 1, wherein the dominant motion is classed in one of the categories: translation, zoom, combination of a translation and of a zoom, static image, depending on the values of tx, ty and k.

7. Process according to claim 1, wherein the motion vector field arises from the encoding of the video sequence considered by a compression algorithm using motion compensation, such as the algorithms complying with the MPEG-1, MPEG-2 or MPEG-4 compression standards.

8. Application of the process according to claim 1 to the selection of key images, an image being selected as a function of the aggregate, over several images, of the information relating to the calculated parameters tx, ty, or k.

9. Device for estimating a dominant motion in a sequence of images comprising a circuit for calculating a motion vector field associated with an image, defining, for an image element with coordinates xi, yi, one or more motion vectors with components ui, vi, wherein it also comprises means of calculation for performing:
a modelling of the motion on the basis of a simplified parametric representation:
ui=tx+k.xi
vi=ty+k.yi
with
tx, ty components of a vector representing the translation component of the motion,
k divergence factor characterizing the zoom component of the motion,
a robust linear regression in each of the two motion representation spaces defined by the planes and, x, y, u and v representing respectively the axes of the variables xi, yi, ui and vi, to give regression lines,
a calculation of the parameters tx, ty, and k on the basis of the ordinates at the origin and slopes of the regression lines.
